(19) United States
(12) Patent Application Publication
(10) Pub. No.: US 2023/0142211 A1
(43) Pub. Date: May 11, 2023

(54) PRISMATIC BATTERY CELL

(71) Applicant: AUDI AG, Ingolstadt (DE)

(72) Inventor: Tamas GYULAI, Pfaffenhofen an der llm (DE)

(73) Assignee: AUDI AG, Ingolstadt (DE)

(21) Appl. No.: 17/973,713

(22) Filed: Oct. 26, 2022

(30) Foreign Application Priority Data
Nov. 11, 2021 (DE) 102021129321.9

(51) Int. Cl. H01M 50/186; H01M 50/103; H01M 50/548; H01M 50/169; H01M 50/15; H01M 50/14

(52) U.S. Cl. CPC H01M 50/186; H01M 50/103; H01M 50/548; H01M 50/169; H01M 50/15; H01M 50/14

(57) ABSTRACT

A prismatic battery cell with a cell housing and several electrodes arranged in an interior of the cell housing, some of which are electrically connected to a first cell terminal accessible from outside the cell housing, and some to a second cell terminal which is also accessible from outside the cell housing. The first cell terminal is arranged on a first side of the cell housing and the second cell terminal is arranged on a second side of the cell housing opposite the first side. One of the cell terminals is arranged on a terminating element which is materially connected to the cell housing and which closes an insertion opening configured in the cell housing, and the terminating element is sealingly connected to the cell housing via a circumferential sealing.

### FIELD

The invention relates to a prismatic battery cell with a cell housing and several electrodes arranged in an interior of the cell housing, some of which are electrically connected to a first cell terminal accessible from outside the cell housing and some to a second cell terminal also accessible from outside the cell housing.

### BACKGROUND

From the prior art, publication DE 10 2020 105 607 B 3 is known, for example. It describes a battery module of a traction battery of a motor vehicle, with a module housing through which cooling medium flows, with several battery cells arranged in the module housing and which can be cooled by the cooling medium, wherein the motor housing has a base body designed as an extruded profile and open at end faces, and wherein the module housing further has end plates, which are inserted into the base body designed as an extruded profile and circumferentially welded to the extruded profile in a fluid-tight manner.

### SUMMARY

It is the object of the invention to propose a prismatic battery cell which has advantages over known battery cells, in particular a high level of operational reliability, particularly preferably with a new configuration.

This is achieved according to the invention with a prismatic battery cell. It is provided that the first cell terminal is arranged on a first side of the cell housing and the second cell terminal is arranged on a second side of the cell housing opposite the first side, wherein one of the cell terminals is arranged on a terminating element which is materially connected to the cell housing and which closes an insertion opening configured in the cell housing, and wherein the terminating element is sealingly connected to the cell housing via a circumferential sealing in order to tightly close the insertion opening against an external environment of the battery cell.

The prismatic battery cell is to be understood as a battery cell which has a specific external shape, namely essentially a cuboid. This means that the cell housing is cuboid or at least has a cuboid basic shape. Of course, attachments can be present on the cell housing or emanate from it, so that overall the battery cell deviates to a certain extent from the cuboid shape. For example, both cell terminals or at least one of the cell terminals project beyond the basically cuboid cell housing, preferably only the at least one cell terminal or the two cell terminals. In addition, at least one opening and/or a recess can be present in the cell housing. Also, edges and/or corners of the cell housing can be rounded. The cell housing preferably consists of metal, in particular aluminum. In principle, however, a configuration of the cell housing of plastic can also be implemented.

The battery cell has several electrodes which are arranged in the cell housing or in the interior of the cell housing. Preferably, at least one of the electrodes is present as an anode and at least another one of the electrodes as a cathode. The anode and cathode are arranged adjacent to each other in the cell housing, wherein there is a separator between them. If several anodes and several cathodes are present, they are arranged in the interior so that the anodes and the cathodes are present alternately. For example, one of the anodes is therefore arranged between two cathodes and/or conversely, one of the cathodes is arranged between two anodes, in particular respectively with a separator arranged between the electrodes.

Each one of the electrodes preferably consists of a carrier on which an electrode material is applied. The carrier is a metal foil, for example. The carrier preferably consists of copper for the anode and of aluminum for the cathode. The electrode material is an anode material in the case of the anode and a cathode material in the case of the cathode. The anode material preferably has graphite, in particular it consists of at least 80 weight %, at least 85 weight % or at least 90 weight % of graphite. The cathode material preferably has a lithium-alloyed material, in particular it consists of at least 80 weight %, at least 85 weight % or at least 90 weight % of the lithium-alloyed material. For example, silicon-cobalt-cobalt(III) oxide, lithium-nickel-manganese-cobalt oxide, lithium-nickel-copper-aluminum oxide, lithium manganese oxide or lithium iron phosphate are used as the lithium-alloyed material. Of course, another cathode material can also be used. The basic structure of the battery cell, in particular the anode material and the cathode material, are known in principle and are therefore not explained further at this point.

In order to enable an electrical contacting of the battery cell from its external environment, the battery cell has the cell terminals, i.e. the first cell terminal and the second cell terminal. The cell terminals are assigned to different potentials of the battery cell or different poles of the battery cell.

For example, one of the cell terminals represents a positive pole and another one of the cell terminals represents a negative pole of the battery cell. The cell terminals are on an outside of the battery cell, so that they can be electrically contacted from the external environment or are accessible for electrical contacting. The prismatic battery cell has a special configuration in which the cell terminals are arranged on opposite sides of the cell housing. Thus, the first cell terminal is on the first side of the cell housing and the second cell terminal is on the second side of the cell housing, wherein the second side is opposite the first side.

The cell terminals are electrically connected to the electrodes. For this purpose, each one of the electrodes has an electrode connection. The electrode connection is formed, for example, by the carrier of the respective electrode. The electrode connection of each one of the electrodes is electrically connected to one of the cell terminals. The electrode connections of all electrodes configured in the same way are preferably each connected to the same cell terminal. This means that the electrode connections of all electrodes configured as anodes are connected to one of the cell terminals, for example the first cell terminal, and/or the electrodes of all electrodes configured as cathodes are connected to another one of the cell terminals, for example the second cell terminal.

The electrodes or their electrode connections are connected to the cell terminals, for example, by means of busbars. The electrodes are therefore electrically connected to the cell terminals via the busbars, in particular exclusively via the busbars. Preferably, the electrode connections of all electrodes configured as anodes are electrically connected to a first busbar and the electrode connections of all electrodes configured as cathodes are electrically connected to a second busbar. The first electrode is now electrically connected to the first cell terminal and the second busbar is electrically connected to the second cell terminal. Thus, several electrodes of the same type (if present) are electrically connected to one another via the busbars. Like the electrodes, the busbars are preferably arranged in the cell housing or the interior of the cell housing.

In addition to the electrodes, the battery cell needs an electrolyte to function. The electrolyte can, for example, be introduced into the cell housing together with the electrodes. For this purpose, the electrolyte is present, for example, on a polymer basis or as an electrolyte foil. Alternatively, it is—preferably—envisaged to fill the electrolyte into the cell housing after the electrodes have been introduced into the latter. Here, the electrolyte is preferably present in liquid form. If both the electrodes and the electrolyte are present in the cell housing, then it is closed, in particular by means of the terminating element, which is attached to the cell housing.

The insertion opening is provided or configured in the cell housing. The insertion opening serves in particular to insert the electrodes into the cell housing. During the manufacture of the battery cell, the electrodes are thus shifted into the interior through the insertion opening. The insertion opening is configured so that the electrodes can be inserted through it into the cell housing or its interior without being damaged. The insertion opening in particular represents a mouth opening of the interior of the cell housing via which the interior is temporarily connected to the external environment of the battery cell during the manufacture of the battery cell.

After insertion of the electrodes into the cell housing and their electrical connection to the cell terminals, the insertion opening is closed, namely with the help of the terminating element. The terminating element closes the insertion opening completely by completely covering or overlapping it. The terminating element preferably rests continuously against an edge that delimits the insertion opening and is formed by the cell housing or by walls of the cell housing. As a result, a certain tightness is already achieved and the penetration of a fluid from the external environment through the insertion opening is made more difficult or even completely prevented.

The terminating element is materially connected to the cell housing, preferably welded to the cell housing, particularly preferably circumferentially and/or in a fluid-tight manner. The terminating element is thus fixed together with the cell terminal with respect to the cell housing. Therefore, the terminating element preferably serves not only to hold the cell terminal on the cell housing, but also to hold the electrodes in the cell housing. The terminating element is preferably connected to the cell housing circumferentially and/or in a fluid-tight manner Circumferential attachment means that the terminating element is attached to the cell housing via a self-contained connecting seam, for example a welded seam. In this way, in particular, the fluid-tight closing of the insertion opening is achieved by the terminating element.

In order to prevent the electrodes or the electrolyte from being adversely affected by environmental influences from the external environment, for example by the fluid penetrating into the interior of the cell housing, there is also the sealing which sealingly connects the terminating element to the cell housing. As a result, the interior is sealed off from the external environment of the battery cell or penetration of a fluid through the insertion opening closed by means of the terminating element is prevented. The sealing is configured to be circumferential, so it encompasses the entire terminating element without interruption. In this case, the sealing rests continuously on the terminating element on the one hand and on the cell housing on the other hand, so that the fluid-tight connection of the terminating element to the cell housing is realized.

A configuration of the prismatic battery cell in which both the material connection of the terminating element to the cell housing and the sealing are configured circumferentially and uninterrupted is particularly preferred. There is therefore a two-step sealing of the battery cell, namely both by means of the material connection and with the help of the sealing.

Both cell terminals are preferably respectively present on a terminating element and each one of these terminating elements is both materially connected to the cell housing and also sealingly connected to the cell housing via a circumferential sealing. Thus, the cell housing has several insertion openings, wherein each one of the insertion openings is closed with one of the terminating elements. In other words, a first one of the cell terminals is arranged on a first terminating element which is materially connected to the cell housing and which closes a first insertion opening configured in the cell housing, wherein the first terminating element is sealingly connected to the cell housing via a circumferential first sealing. Additionally, a second one of the cell terminals is arranged on a second terminating element which is materially connected to the cell housing and which closes a second insertion opening configured in the cell housing, wherein the second terminating element is sealingly connected to the cell housing via a circumferential second sealing. The insertion openings and the terminating elements are present at a distance from one another or are arranged or configured at a distance from one another on the cell housing.

The cell housing is present, for example, as a hollow cylinder, more precisely as a hollow cuboid. Thus, it has several walls, wherein, when the battery cell is arranged as intended, a first one of the walls and a second one of the walls are present as side walls, a third one of the walls forms a bottom of the cell housing and a fourth one of the walls forms a ceiling of the cell housing. In this case, the side walls are arranged parallel to each other, as are the bottom and the ceiling. The side walls are also each arranged perpendicular to the bottom and the ceiling. The insertion opening is on one end face of the cell housing or the insertion openings are on opposite end faces of the cell housing. The insertion opening or the insertion openings are (respectively) delimited by a continuous edge which is formed jointly by the first wall, the second wall, the third wall and the fourth wall. A surface area of the insertion opening or of the terminating element is preferably smaller than the surface area of each one of the walls of the cell housing. In particular, the surface area of the insertion opening is smaller than the surface area of each one of the side walls.

It can be provided to combine several of the prismatic battery cells into one cell module. Such a cell module has a module housing in which the several battery cells are arranged. The cell terminals of the battery cells are electrically connected to electrical connections of the cell module. For example, the battery cells are connected electrically in series or electrically in parallel with one another between the electrical connections. The cell module preferably has a cooling device, by means of which the battery cell is at least temporarily cooled. For this purpose, for example at least one heat exchanger is arranged adjacent to the battery cells, through which a cooling medium flows at least temporarily in order to dissipate heat from the battery cells.

The described configuration of the battery cell enables simple production and reliable electrical contacting. This is achieved by arranging the cell terminals on opposite sides of the battery cell or of the cell housing. However, this means that when the battery cell is exposed to a fluid, in particular water, for example fluid that is present in the module housing, the insertion opening of the cell housing is partially submerged. In order to still reliably prevent the fluid from penetrating into the interior of the cell housing, the circumferential sealing is arranged between the terminating element and the cell housing and the terminating element is also materially connected to the cell housing. This achieves the advantages already described.

A further development of the invention provides that the material connection of the terminating element to the cell housing is present along a circumferential connecting seam. The material connection is established by means of the connecting seam, i.e. the terminating element is materially connected to the cell housing. The connecting seam is preferably a weld seam, so that the material connection is produced by welding. The connecting seam is circumferential and uninterrupted, so it is self-contained. As a result, a fluid-tight closure of the insertion opening is already realized by means of the terminating element, so that the penetration of fluid from the external environment into the interior of the cell housing is reliably prevented.

A further development of the invention provides that the connecting seam is present as a weld seam. This has already been addressed. The terminating element is attached to the cell housing by welding and is thus materially connected to it. This ensures a reliable attachment of the terminating element to the cell housing.

A further development of the invention provides that the connecting seam is arranged on a side of the sealing facing the external environment along an imaginary flow path between the external environment and the interior. The flow path is purely hypothetical, in fact it is not present in such a form so that fluid can travel along the flow path from the external environment to the interior. At most, the flow path can be present as long as the terminating element is not yet materially connected to the cell housing and the sealing is not inserted between the terminating element and the cell housing. In other words, the flow path is present at most when the terminating element is loosely inserted into the insertion opening. The concept of the flow path serves only to define a hypothetical flow direction of the fluid from the external environment in the direction of the interior.

In relation to the imaginary flow path, the connecting seam should be on the outside and the sealing should be on the inside. For example, the connecting seam is present on a side of the cell housing and of the terminating element that faces the external environment. Accordingly, the connecting seam can be produced from the external environment and is also visible after it has been produced. The sealing, on the other hand, is arranged between the connecting seam and the interior in relation to the imaginary flow path. Thus, it is covered by the cell housing, the terminating element and the connecting seam and is therefore not recognizable from the external environment. Such an arrangement of the connecting seam and the sealing ensures a particularly good tightness of the battery cell, since the advance of the fluid to the sealing is already reliably prevented by means of the connecting seam.

A further development of the invention provides that the sealing is arranged at a distance from the connecting seam. This applies in particular with regard to the imaginary flow path, which has already been explained. The connecting seam preferably lies continuously in an imaginary first plane and the sealing lies continuously in an imaginary second plane. The first plane represents, for example, a central plane of the connecting seam and the second plane represents a central plane of the sealing. The two planes are preferably arranged parallel to one another at a distance from one another, namely in such a way that the sealing does not rest against the connecting seam but is at a distance from it. This particularly reliably ensures a good sealing effect, since under certain circumstances fluid penetrating through a damaged connecting seam in the direction of the interior must first reach the sealing through a gap between the terminating element and the cell housing and is then stopped by it.

A further development of the invention provides that the sealing is inserted into a sealing receptacle which is configured in the terminating element or the cell housing. The sealing receptacle is meant to be a recess, preferably a continuous and uninterrupted recess, in which the sealing is arranged. The depth of the sealing receptacle is selected so that the sealing protrudes from it after it has been arranged in the sealing receptacle. Thus, a depth of the sealing receptacle is less than a material thickness of the sealing. A simple introduction of the terminating element through the insertion opening into the cell housing is possible by means of the sealing receptacle configured in the terminating element and the sealing arranged in it. Alternatively, of course, the sealing receptacle can also be present in the cell housing. The insertion of the sealing into the sealing receptacle allows easy and reliable positioning of the sealing and thus ensures a good sealing effect.

A further development of the invention provides that the sealing is configured integrally with the terminating element or the cell housing, in particular is injection molded onto the terminating element or the cell housing. The integral arrangement of the sealings on the terminating element or the cell housing enables a particularly good sealing effect. If the sealing is configured integrally with the terminating element, the sealing and the terminating element can also be made of the same material, i.e. consist of the same material. However, the sealing and the terminating element are preferably made of different materials. In this case, for example, the sealing and the terminating element are produced by means of a multi-component injection molding method. The described configuration of the battery cell enables a particularly good sealing effect.

A further development of the invention provides that the cell housing has a terminating element receptacle which is encompassed by a circumferential step configured on the cell housing, wherein the terminating element rests on the step or is supported on the step via the sealing. The terminating element receptacle serves to at least partially receive the terminating element. The insertion opening represents, for example, a mouth opening of the terminating element receptacle facing the external environment. The terminating element receptacle is present as a stepped receptacle, i.e. it has different dimensions in a direction parallel to the insertion opening or mouth opening. In particular, the terminating element receptacle tapers in the direction of the interior, namely due to the formation of the circumferential step.

After the material connection of the terminating element to the cell housing at the latest, the terminating element should either rest on this step or be supported on the step via the sealing. This ensures a reliable sealing. If the terminating element directly rests on the step, this rest achieves a further sealing, which is present in addition to the material connection of the terminating element to the cell housing and the sealing. If the terminating element is supported on the step by the sealing, the sealing is compressed by this support and its sealing effect is improved. In any case, a high tightness is realized.

A further development of the invention provides that another one of the cell terminals is arranged on a further terminating element which is materially connected to the cell housing and which closes a further insertion opening configured in the cell housing, wherein the further terminating element is sealingly connected to the cell housing via a further circumferential sealing in order to tightly close the further insertion opening in relation to an external environment of the battery cell. Such a configuration of the battery cell has already been mentioned. The terminating element can also be referred to as the first terminating element and the further terminating element can be referred to as the second terminating element. The situation is analogous for the insertion opening and the further insertion opening, which can also be referred to as the first insertion opening and the second insertion opening, and for the sealing, wherein the sealing represents the first sealing and the further sealing represents the second sealing. The further terminating element, the further insertion opening and the further sealing are preferably configured and arranged analogously to the terminating element, the insertion opening and the sealing. In this regard, reference is made to the corresponding explanations above.

A further development of the invention provides that the cell housing is configured as a hollow cylinder and has the insertion opening on the first side and the additional insertion opening on the second side. In this case, the first cell terminal is on the first terminating element on the first side and the second cell terminal is on the second terminating element on the second side. Such a configuration of the battery cell enables a simple production.

The features and feature combinations described in the description, in particular the features and feature combinations described below in the description of the figures and/or shown in the figures may be used not only in the respective combination specified, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURES

In the following, the invention will be explained in greater detail with reference to the exemplary embodiments depicted in the drawings, without this restricting the invention. The following is shown:

FIG. 1 shows a schematic representation of a prismatic battery cell with a cell housing which is closed on the inside by terminating elements,

FIG. 2 shows a schematic sectional representation of the prismatic battery cell in a first embodiment, and

FIG. 3 shows a schematic representation of the prismatic battery cell in a second embodiment.

### DETAILED DESCRIPTION

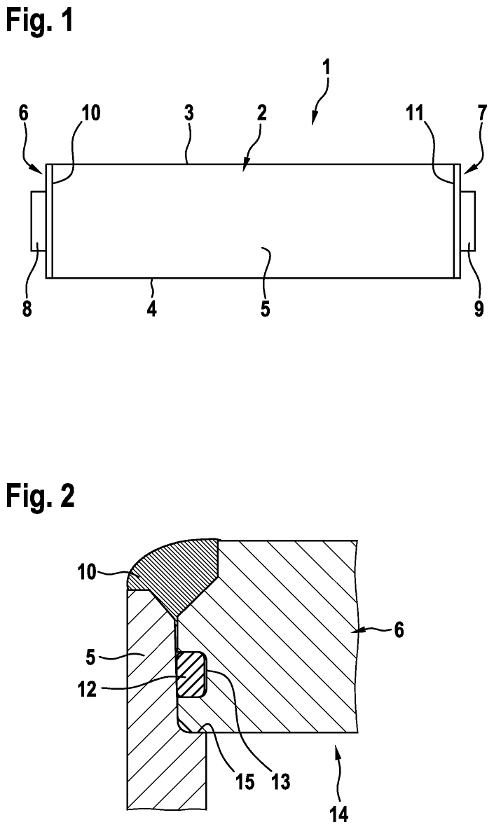

FIG. 1 shows a schematic representation of a prismatic battery cell 1 in plan view. The battery cell 1 has a cell housing 2, of which walls 3, 4 and 5 can be seen here. The walls 3 and 4 are spaced apart in parallel and are connected to one another by the wall 5. The walls 3 and 4 are side walls of the cell housing 2, the wall 5 forms a ceiling of the cell housing 2. Spaced parallel to the wall 5 there is a wall, not recognizable here, which forms a bottom of the cell housing 2 and also connects the walls 3 and 4 to one another. The walls 3, 4 and 5 and the non-visible wall together form the hollow cylindrical or hollow cuboid cell housing 2.

On end faces of the cell housing 2, it has insertion openings, not further represented, which are closed by means of terminating elements 6 and 7. There is a first cell terminal 8 on the first terminating element 6 and a second cell terminal 9 on the second terminating element 7. Electrodes of the battery cell 1 arranged in the cell housing 2 can be electrically contacted from the outside via the cell terminals 8 and 9. For this, the electrodes are electrically connected to the cell terminals 8 and 9.

The terminating elements 6 and 7 are each attached to the cell housing 2 via a connecting seam 10 and 11, respectively. The connecting seams 10 and 11 are preferably present as weld seams, so that there is a material connection of the terminating elements 6 and 7 to the cell housing 2. This connection is preferably configured to be circumferential, so that the connecting seams 10 and 11 are also configured to be circumferential and uninterrupted. As a result, the battery cell 1 is reliably sealed, so that the electrodes arranged in the interior of the cell housing 2 are protected from environmental influences from the external environment, in particular fluid present in the external environment.

FIG. 2 shows a sectional representation of the battery cell 1 in a first embodiment. It shows the wall 5, the terminating element 6 and the connecting seam 10 via which the terminating element 6 is materially attached to the wall 5. The connecting seam 10 is represented as a weld seam. A sealing 12 is arranged between the wall 5 and the terminating element 6 for additional sealing of the battery cell 1. The sealing 12 rests sealingly on the wall 5 on the one hand and on the terminating element 6 on the other hand. In this case, it is arranged in a sealing receptacle 13 which is formed in the terminating element 6. The insertion opening, which is closed by the terminating element 6, is a mouth opening of a terminating element receptacle 14 in which the terminating element 6 is arranged. The terminal element receptacle 14 is present as a stepped receptacle and is encompassed by a step 15 configured on the cell housing 2. The terminating element 6 preferably rests on the step 15 in a circumferential and continuous manner in order to achieve an additional sealing effect.

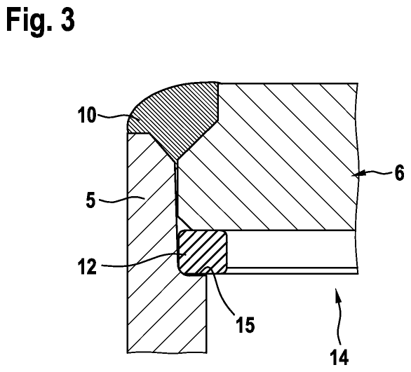

FIG. 3 shows a schematic representation of the battery cell 1 in a second embodiment. In principle, reference is made to the above explanations and reference is only made to the differences between the first embodiment and the second embodiment. These lie in the fact that the sealing 12 is not arranged in the sealing receptacle 13 but is held clamped between the terminating element 6 and the step 15. Thus, the sealing 12 rests on the terminating element 6 on the one hand and on the step 15 on the other hand with pretension. A particularly good sealing effect is achieved by the clamping force acting on the sealing 12.

### LIST OF REFERENCE NUMERALS

1 battery cell
2 cell housing
3 wall
4 wall
5 wall
6 terminating element
7 terminating element
8 cell terminal
9 cell terminal
10 connecting seam
11 connecting seam
12 sealing
13 sealing receptacle
14 terminating element receptacle
15 step

1. A prismatic battery cell, comprising: a cell housing and several electrodes arranged in an interior of the cell housing, some of which are electrically connected to a first cell terminal accessible from outside the cell housing, and some to a second cell terminal also accessible from outside the cell housing, wherein the first cell terminal is arranged on a first side of the cell housing and the second cell terminal is arranged on a second side of the cell housing opposite the first side, wherein one of the cell terminals is arranged on a terminating element which is materially connected to the cell housing and which closes an insertion opening configured in the cell housing, and wherein the terminating element is sealingly connected to the cell housing via a circumferential sealing in order to sealingly close the insertion opening in relation to an external environment of the battery cell.

2. The prismatic battery cell according to claim 1, wherein the material connection of the terminating element to the cell housing is present along a circumferential connecting seam.

3. The prismatic battery cell according to claim 2, wherein the connecting seam is present as a weld seam.

4. The prismatic battery cell according to claim 2, wherein the connecting seam is arranged on a side of the sealing facing the external environment along an imaginary flow path between the external environment and the interior.

5. The prismatic battery cell according to claim 2, wherein the sealing is arranged at a distance from the connecting seam.

6. The prismatic battery cell according to claim 1, wherein the sealing is inserted into a sealing receptacle which is configured in the terminating element or the cell housing.

7. The prismatic battery cell according to claim 1, wherein the sealing is integrally configured with the terminating element or the cell housing.

8. The prismatic battery cell according to claim 1, wherein the cell housing (2) has a terminating element receptacle (14) which is encompassed by a circumferential step (15) formed on the cell housing, wherein the terminating element rests on the step or is supported on the step via the sealing.

9. The prismatic battery cell according to claim 1, wherein another one of the cell terminals is arranged on a further terminating element which is materially connected to the cell housing and which closes a further insertion opening configured in the cell housing, wherein the further terminating element is sealingly connected to the cell housing via a further circumferential sealing in order to tightly close the further insertion opening in relation to the external environment of the battery cell.

10. The prismatic battery cell according to claim 1, wherein the cell housing is configured as a hollow cylinder and has the insertion opening on the first side and the further insertion opening on the second side.

11. The prismatic battery cell according to claim 3, wherein the connecting seam is arranged on a side of the sealing facing the external environment along an imaginary flow path between the external environment and the interior.

12. The prismatic battery cell according to claim 3, wherein the sealing is arranged at a distance from the connecting seam.

13. The prismatic battery cell according to claim 4, wherein the sealing is arranged at a distance from the connecting seam.

14. The prismatic battery cell according to claim 2, wherein the sealing is inserted into a sealing receptacle which is configured in the terminating element or the cell housing.

15. The prismatic battery cell according to claim 3, wherein the sealing is inserted into a sealing receptacle which is configured in the terminating element or the cell housing.

16. The prismatic battery cell according to claim 4, wherein the sealing is inserted into a sealing receptacle which is configured in the terminating element or the cell housing.

17. The prismatic battery cell according to claim 5, wherein the sealing is inserted into a sealing receptacle which is configured in the terminating element or the cell housing.

18. The prismatic battery cell according to claim 2, wherein the sealing is integrally configured with the terminating element or the cell housing.

19. The prismatic battery cell according to claim 3, wherein the sealing is integrally configured with the terminating element or the cell housing.

20. The prismatic battery cell according to claim 4, wherein the sealing is integrally configured with the terminating element or the cell housing.
